(19) United States
(12) Patent Application Publication
(10) Pub. No.: US 2025/0273965 A1
(43) Pub. Date: Aug. 28, 2025

(54) Safety and stability analysis method for new energy power system based on Lyapunov function

(71) Applicant: North China Electric Power University, Beijing (CN)

(72) Inventors: Tong Wang, Beijing (CN); Xiaotong Wang, Beijing (CN); Zichang Han, Beijing (CN); Zengping Wang, Beijing (CN)

(73) Assignee: North China Electric Power University, Beijing (CN)

(21) Appl. No.: 19/196,735

(22) Filed: May 1, 2025

Related U.S. Application Data
(63) Continuation of application No. PCT/CN2025/082792, filed on Mar. 16, 2025.

(30) Foreign Application Priority Data
Aug. 12, 2024 (CN) CN202411097144.3

(51) Int. Cl. H02J 3/38; G06F 30/20; G06F 113/04

(52) U.S. Cl. CPC H02J 3/38; G06F 30/20; G06F 2113/04; H02J 2203/20; H02J 2300/20

(57) ABSTRACT

The present disclosure discloses a safety and stability analysis method for a new energy power system based on Lyapunov function, including: obtaining a new energy grid connection point voltage, a new energy grid connection point voltage phase angle, an internal potential of a synchronous machine, a line susceptance and a rotor position angle of the synchronous machine of the new energy power system, to obtain an output power of synchronous machine; obtaining a synchronous machine rotor motion equation according to the output power of synchronous machine; constructing a Lyapunov function of synchronous machine based on the new energy power system according to the synchronous machine rotor motion equation; obtaining a stability domain boundary of the synchronous machine with respect to the state variables according to the Lyapunov function; determining a transient stability of the synchronous machine according to real-time values of post-fault state variables.

### CROSS-REFERENCE TO RELATED APPLICATION

This application is a US Utility continuation application claiming priority to International Application No. PCT/CN2025/082792, filed on Mar. 16, 2025, entitled “Safety and stability analysis method for new energy power system based on Lyapunov function”, which claims priority to Chinese Application No. 202411097144.3, filed on Aug. 12, 2024, incorporated herein by reference in their entirety.

### TECHNICAL FIELD

The present disclosure relates to the technical field of safety analysis of new energy stations, and in particular to a safety and stability analysis method for a new energy power system based on Lyapunov function.

### BACKGROUND

Since the goal of “carbon peak and carbon neutrality” was proposed, the construction of a new power system dominated by clean energy has become the main development direction of China's future energy and electricity, and a high proportion of new energy access will become the basic feature and development form of the modern power system. However, the increasing load demand, operating conditions closer to the system limit, larger interconnected power grids and more new energy units connected by power electronic components have made the modern power system more complex, and the operation of the power system is facing more severe challenges. In order to provide safe and reliable power services, the stability of these modern power systems and power supply equipments must be maintained. The growth and evolution of the scale of modern power systems and the operating conditions of power systems close to their limit have led to different forms of instability problems. Therefore, the stability of modern power systems has become increasingly important for the safe operation of power grids.

### SUMMARY

In order to solve the above-mentioned problems in the prior art, the present disclosure provides a safety and stability analysis method for a new energy power system based on Lyapunov function. It has low construction difficulty, it is universal for different forms of nonlinear systems, and it has fast and accurate transient stability assessment.

In order to achieve the above-mentioned invention object, the present disclosure provides a safety and stability analysis method for a new energy power system comprising a synchronous machine based on Lyapunov function, comprising following steps:
obtaining a new energy grid connection point voltage, a new energy grid connection point voltage phase angle, an internal potential of a synchronous machine, a line susceptance and a rotor position angle of the synchronous machine of the new energy power system;
obtaining an output power of synchronous machine according to the new energy grid connection point voltage, the new energy grid connection point voltage phase angle, the internal potential of the synchronous machine, the line susceptance and the rotor position angle of the synchronous machine, wherein the output power of synchronous machine is:

$${P}_{gk} = {E}_{gk} {\sum }_{m = 1}^{n} {E}_{gm} {B}_{mk} sin ( {δ}_{gk} - {δ}_{gm} ) + {E}_{gk} {\sum }_{i = 1}^{i} {U}_{bi} {B}_{wgik} sin ( {δ}_{gk} - {δ}_{hi} ) ;$$

where, P_{gk} is an output power of the k-th synchronous machine, E_{gk} is an internal potential of the k-th synchronous machine, k is a serial number of the current synchronous machine, m is a serial number of the synchronous machine, n is a total number of synchronous machines, E_{gm} is an internal potential of the m-th synchronous machine, Bₘₖ is a line susceptance between the k-th synchronous machine and the m-th synchronous machine, δ_{gk} is a rotor position angle of the k-th synchronous machine, δ_{gm} is a rotor position angle of the m-th synchronous machine, i is a serial number of the new energy grid connection point, l is a total number of new energy grid connection points, U_{bi} is a voltage of the i-th new energy grid connection point, B_{wgik} is a line susceptance between the k-th synchronous machine and the i-th new energy grid connection point, and δ_{bi} is a voltage phase angle of the i-th new energy grid connection point;
obtaining an inertia constant of synchronous machine, a prime mover power of synchronous machine and a center of inertia time constant of synchronous machine based on the new energy power system;
obtaining a synchronous machine rotor motion equation according to the inertia constant of synchronous machine, the prime mover power of synchronous machine and the center of inertia time constant of synchronous machine and the output power of synchronous machine, wherein state variables of the synchronous machine rotor motion equation comprises a synchronous machine rotor position angle and a synchronous machine rotor angular velocity;
constructing a Lyapunov function of synchronous machine based on the new energy power system according to the synchronous machine rotor motion equation;
obtaining a stability domain boundary of the synchronous machine with respect to the state variables according to the Lyapunov function;
based on the stability domain boundary, determining a transient stability of the synchronous machine according to real-time values of post-fault state variables; and
adjusting the operation of the synchronous machine according to the transient stability of the synchronous machine.

According to some embodiments of the present disclosure, the new energy grid connection point voltage is:

$${U}_{bi} = {X}_{wwi} \sqrt{{( {\sum }_{m = 1}^{n} \frac{{E}_{gm}}{{X}_{wgim}} sin {δ}_{gm} )}^{2} + {( {\sum }_{m = 1}^{n} \frac{{E}_{gm}}{{X}_{wgim}} cos {δ}_{gm} )}^{2} - {I}_{wi}^{2}} ;$$

the new energy grid connection point voltage phase angle is:

$${δ}_{bi} = {tan}^{- 1} ( {\sum }_{m = 1}^{n} \frac{{E}_{gm}}{{X}_{wgim}} cos {δ}_{gm} / ( - {\sum }_{m = 1}^{n} \frac{{E}_{gm}}{{X}_{wgim}} sin {δ}_{gm} ) ) - arctan \frac{{U}_{bi}}{{X}_{wwi} {I}_{wi}}$$

where, U_{bi} is a voltage of the i-th new energy grid connection point, X_{wwi} is a self-reactance of the i-th new energy grid connection point, m is a serial number of the synchronous machine, n is a total number of synchronous machines, E_{gm} is an internal potential of the m-th synchronous machine, X_{wgim} is a reactance between the m-th synchronous machine and the i-th new energy grid connection point, δ_{gm} is a rotor position angle of the m-th synchronous machine, I_{wi} is an injected current of the i-th new energy grid connection point, and δ_{bi} is a voltage phase angle of the i-th new energy grid connection point.

According to some embodiments of the present disclosure, the synchronous machine rotor motion equation is:

$$\{ \begin{matrix}\frac{d {δ}_{gk}}{dt} = {ω}_{k} \\ {M}_{k} \frac{d {ω}_{k}}{dt} = {P}_{k} - {P}_{gk} - \frac{{M}_{k}}{{M}_{COI}} {P}_{COI}\end{matrix} ;$$

$$where :$$

$${M}_{COI} = {\sum }_{k = 1}^{n} {M}_{k} ;$$

$${P}_{COI} = {\sum }_{k = 1}^{n} ( {P}_{k} - {P}_{gk} ) ;$$

where, δ_{gk} is a rotor position angle of the k-th synchronous machine, ωₖ is a rotor angular velocity of the k-th synchronous machine, Mₖ is an inertia time constant of the k-th synchronous machine, Pₖ is a prime mover power of the k-th synchronous machine, P_{gk} is an output power of the k-th synchronous machine, M_{COI} is a center of inertia time constant of the n-th synchronous machine, P_{COI} is an inertia center power of the n-th synchronous machine, k is a serial number of the current synchronous machine, and n is a total number of synchronous machines.

According to some embodiments of the present disclosure, the step of constructing the Lyapunov function comprises:
based on the synchronous machine rotor motion equation, acquiring a sample set in a preset area, wherein the sample set is a set of values of the state variables;
initializing parameters and number of iterations of a neural network;
obtaining an output scalar function based on the sample set and the parameters of the neural network;
obtaining an output risk function according to the sample set, the parameters of the neural network, the output scalar function and the motion equation;
inputting or setting operating parameters of the neural network, the operating parameters comprising input dimension, output dimension, hidden layer dimension, learning rate and maximum number of iterations; obtaining the input dimension according to the synchronous machine rotor motion equation, and obtaining the output dimension according to the output scalar function;
obtaining an activation function of the neural network;
running the neural network based on the operating parameters, the parameters of the neural network, the number of iterations, the activation function, the output scalar function, and the output risk function, to obtain an output function;
obtaining the Lyapunov function of synchronous machine based on the new energy power system according to the output function.

According to some embodiments of the present disclosure, the operation steps of the neural network comprises:
Step 1: determine whether t<tₘₐₓ is met, where t is the number of iterations and tₘₐₓ is the maximum number of iterations:
if not, modify the preset area or the sample set;
if yes, run the neural network;
Step 2: update the parameters of the neural network according to the output risk function, and obtain the output function according to the output scalar function;
Step 3: determine whether the output function meets an output verification condition:
if the output function does not meet the output verification condition, then t=t+1, repeat step 1 to step 2;
if the output function meets the output verification condition, then the output function is set as the Lyapunov function.

According to some embodiments of the present disclosure, the output risk function is:

$$L ( x ; θ ) = \frac{1}{N} {\sum }_{s = 1}^{N} ( {h}_{1} ( V ( {x}_{s} ; θ ) ) + {h}_{2} ( {∇}_{x} {V ( {x}_{s} ; θ )}^{T} f ( {x}_{s} ) ) ) + {V}^{2} ( θ ) ;$$

$$where :$$

$${h}_{1} ( V ) = \{ \begin{matrix}0 if V > {m}_{1} \\ - V + {m}_{1} if V \leq {m}_{1}\end{matrix} ,$$

$${h}_{2} ( \dot{V} ) = \{ \begin{matrix}\dot{V} + {m}_{2} if \dot{V} > - {m}_{2} \\ 0 if \dot{V} \leq - {m}_{2}\end{matrix} ;$$

where, L is an output risk function, x is a value of state variable, θ is a parameter of the neural network, N is a total number of samples, s is a sample number, xₛ is a value of the state variable of the s-th sample, f is a function corresponding to the synchronous machine rotor motion equation, ∇ₓ is a partial differential with respect to x, T represents a transpose, h₁ is a constraint function of V, h₂ is a constraint function of \dot{V}, \hat{V} is an output scalar function, m₁ is a margin of the output function from the origin, m₂ is a margin of the derivative of the output function from the origin, m₁≥0, m₂≥0, V is the output function, and \dot{V} is the derivative of the output function.

According to some embodiments of the present disclosure, the step of determining whether the output function meets the output verification condition comprises:
based on a solver, obtaining a verification function according to the sample set and the output function, wherein the verification function is:

$${Φ}_{ε} ( x ) = ( {\sum }_{s = 1}^{N} {x}_{s}^{2} \geq ε ) ⋀ ( V ( x ) \leq 0 ⋁ \dot{V} ( x ) \geq 0 ) ;$$

where: Φ is the verification function, N is the total number of samples, s is the sample number, xₛ is the value of the state variable of the s-th sample, ε is a small constant parameter that limits a tolerable numerical error, x is the value of the state variable, V is the output function, \dot{V} is the derivative of the output function, ε∈Q⁺, Q⁺ is a set of positive rational numbers;
using the solver to solve the verification function and determining whether the verification function holds;
if the verification function does not hold, then the output function does not meet the output verification condition;
if the verification function holds, the output function meets the output verification condition.

According to some embodiments of the present disclosure, when the verification function does not hold, the value of state variable of the output function that does not meet the output verification condition is obtained according to the verification function, and the value of state variable of the output function that does not meet the output verification condition is added to the sample set, and the sample set is updated; and the Steps 1 to 2 are repeated based on the updated sample set.

According to some embodiments of the present disclosure, the output verification condition is:
V(0)=0 and V(x)>0 in D−{0},
V(x)<0 in D−{0};
where, V is the output function, x is the value of the state variable, D is the preset area, and \dot{V} is the derivative of the output function.

According to some embodiments of the present disclosure, the hidden layer dimension is 7.

### BRIEF DESCRIPTION OF THE DRAWINGS

FIG. 1 is a schematic diagram of the steps of the analysis method disclosed herein;

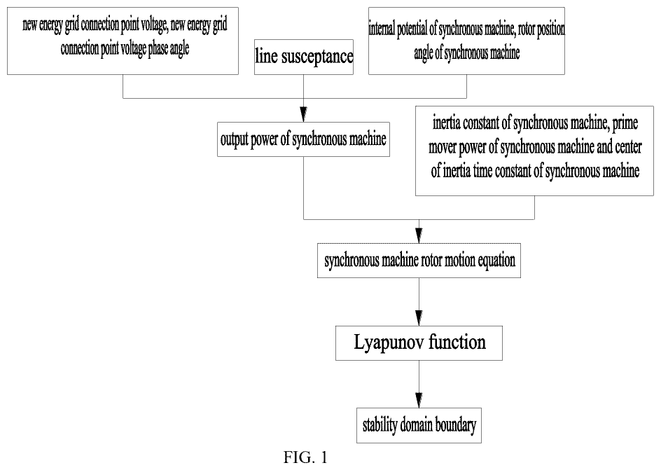

FIG. 2 is a schematic flow chart of the process for constructing a Lyapunov function in the present disclosure;

FIG. 3 is a schematic diagram of a topological network structure of a three-machine nine-node new energy power system in an example of the present disclosure;

FIG. 4 shows a Lyapunov function of the synchronous machine G1 under working condition 1 in an example of the present disclosure;

FIG. 5 shows a derivative of the Lyapunov function of the synchronous machine G1 under working condition 1 in the example of the present disclosure;

FIG. 6 shows a Lyapunov function of the synchronous machine G1 under working condition 2 in an example of the present disclosure;

FIG. 7 shows a derivative of the Lyapunov function of the synchronous machine G1 under working condition 2 in the example of the present disclosure;

FIG. 8 is a schematic diagram of the stability domain boundary under working condition 2 in the example of the present disclosure.

### DETAILED DESCRIPTION OF EMBODIMENTS

Online transient stability assessment is conducive to taking timely measures to maintain the stability of the power system, which is of great significance for the forward-looking dispatching and planning of the power system. With the widespread deployment of phasor measurement units in the power grid, a large amount of power grid measurement data can be obtained synchronously to capture the state and dynamic of the entire system in real time. Based on a large amount of power grid measurement data, data-driven transient stability assessment is a fast and efficient way. In particular, with the help of advanced artificial intelligence methods, the potential relationship between the operating state variables and the stability state of the power system under study can be fully revealed. As a data-driven stability judgment, these relationships can be used to achieve fast and accurate transient stability assessment.

The transient stability of the power system, also known as the “first swing” stability, refers to the ability of each synchronous generator to maintain synchronous rotation and convert to a new state or restore to the original stable working state after the power system suffers a large disturbance. Transient instability is also the main factor leading to large-scale power outages. The occurrence of large-scale power system power outages will seriously affect people's production and life and cause huge economic losses. The Lyapunov function construction method applied to traditional power systems is only applicable to specified models. It mainly uses energy functions and sum-of-squares programming methods. The sum-of-squares programming method is limited to polynomial systems. For non-polynomial systems, it is necessary to first use Taylor series expansion to approximate the motion equations, and then calculate the stability domain based on the approximate polynomial equations. Compared with traditional power systems, power systems with new energy access have more complex characteristics. The Lyapunov function construction method applied to traditional power systems has the problem of non-integrability for complex systems, making it difficult to obtain energy functions, and cannot handle nonlinear systems of different forms. There is no universal Lyapunov function construction method for power systems with new energy access.

The beneficial effects of the present disclosure are:
1. The present disclosure calculates the output power of the synchronous machine according to the voltage of the new energy grid connection point, the voltage phase angle of the new energy grid connection point, the internal potential of the synchronous machine, the line susceptance and the synchronous machine rotor position angle in the new energy power system, and obtains the synchronous machine rotor motion equation based on the output power of the synchronous machine to construct the Lyapunov function, which linearizes the complex nonlinear system and reduces the difficulty of constructing the Lyapunov function. It is a general construction method of the Lyapunov function of power systems with different forms having new energy access;
2. Based on the stability domain boundary determined by the Lyapunov function constructed in the present disclosure, by observing the real-time values of the synchronous machine rotor position angle and the synchronous machine rotor angular velocity in the new energy power system after a fault, and judging whether these two state variables are within the stability domain boundary to judge the transient stability of the synchronous machine, and then conducting a safety and stability analysis of the new energy power system, a fast and accurate transient stability assessment of the new energy power system is achieved.

The existing technology is limited in constructing the Lyapunov function of synchronous machines in new energy power systems. In order to maintain the safe and stable operation of the power supply system and prevent large-scale power outages, a rapid and accurate transient stability assessment method is urgently needed, the method should be suitable for the safety and stability analysis of power systems with new energy access, and can provide information guarantee for the effective implementation of prevention and emergency control measures for transient stability operation of new energy power systems after faults occur.

In order to clearly illustrate the technical features of this solution, this solution is described below through a specific implementation method.

Embodiments of the present disclosure provide a method for safety and stability analysis of a new energy power system based on the Lyapunov function. Specifically, in a new energy power system, there are n synchronous machines and l new energy grid connection points in total. The output power of the k-th synchronous machine is expressed as formula (1):

$${P}_{gk} = Re ( {\dot{E}}_{gk} {{I}^{\hat{.}}}_{k} ) = Re ( {\dot{E}}_{gk} {\sum }_{m = 1}^{n} {{Y}^{\hat{.}}}_{mk} {{E}^{\hat{.}}}_{gm} + {\dot{E}}_{gk} {\sum }_{i - 1}^{l} {{Y}^{\hat{.}}}_{wgik} {{U}^{\hat{.}}}_{bi} ) \qquad ( 1 )$$

In the formula, P_{gk} is the output power of the k-th synchronous machine, Re represents the real part, Ė_{gk} is the derivative of the internal potential of the k-th synchronous machine, k is the serial number of the current synchronous machine, m is the synchronous machine serial number, n is the total number of synchronous machines, \dot{Î}ₖ is the conjugate of the injected current of the k-th synchronous machine, \dot{Ŷ}ₘₖ is the conjugate of the admittance between the k-th synchronous machine and the m-th synchronous machine, \dot{Ê}_{gm} is the phasor of the derivative of the internal potential the m-th synchronous machine, i is the serial number of the new energy grid connection point, l is the total number of new energy grid connection points, \dot{Ŷ}_{wgik} is the conjugate of the mutual admittance between the k-th synchronous machine and the i-th new energy grid connection point, \dot{Û}_{bi} is the phasor of the derivative of the voltage at the i-th new energy grid connection point;

When the line resistance is ignored, equation (1) can be expressed as equation (2):

$${P}_{gk} = {E}_{gk} {\sum }_{m = 1}^{n} {E}_{gm} {B}_{mk} sin ( {δ}_{gk} - {δ}_{gm} ) + {E}_{gk} {\sum }_{i = 1}^{l} {U}_{bi} {B}_{wgik} sin ( {δ}_{gk} - {δ}_{bi} ) \qquad ( 2 )$$

In the formula, P_{gk} is an output power of the k-th synchronous machine, E_{gk} is an internal potential of the k-th synchronous machine, k is a serial number of the current synchronous machine, m is a serial number of the synchronous machine, n is a total number of synchronous machines, E_{gm} is an internal potential of the m-th synchronous machine, Bₘₖ is a line susceptance between the k-th synchronous machine and the m-th synchronous machine, δ_{gk} is a rotor position angle of the k-th synchronous machine, δ_{gm} is a rotor position angle of the m-th synchronous machine, i is a serial number of the new energy grid connection point, l is a total number of new energy grid connection points, U_{bi} is a voltage of the i-th new energy grid connection point, B_{wgik} is a line susceptance between the k-th synchronous machine and the i-th new energy grid connection point, and δ_{bi} is a voltage phase angle of the i-th new energy grid connection point;

Therefore, based on formula (2), after obtaining the voltage at the grid connection point of the new energy power system, the voltage phase angle at the grid connection point of the new energy power system, the internal potential of the synchronous machine, the line susceptance and the synchronous machine rotor position angle, the output power of the synchronous machine can be calculated according to formula (1); the complex nonlinear system is linearized to reduce the difficulty of constructing the Lyapunov function suitable for the new energy power system;

On the basis of formula (2), based on the new energy power system, the synchronous machine rotor motion equation can be obtained by obtaining the synchronous machine inertia constant, the synchronous machine prime mover power and the synchronous machine inertia center (center of inertia) time constant. The state variables of the synchronous machine rotor motion equation are the synchronous machine rotor position angle and the synchronous machine rotor angular velocity; the synchronous machine rotor motion equation is:

$$\{ \begin{matrix}\frac{d {δ}_{gk}}{dt} = {ω}_{k} \\ {M}_{k} \frac{d {ω}_{k}}{dt} = {P}_{k} - {P}_{gk} \frac{{M}_{k}}{{M}_{COI}} {P}_{COI}\end{matrix} ;$$

$$where :$$

$${M}_{COI} = {\sum }_{k = 1}^{n} {M}_{k} ;$$

$${P}_{COI} = {\sum }_{k = 1}^{n} ( {P}_{k} - {P}_{gk} ) ;$$

In the formula, δ_{gk} is a rotor position angle of the k-th synchronous machine, ωₖ is a rotor angular velocity of the k-th synchronous machine, Mₖ is an inertia time constant of the k-th synchronous machine, Pₖ is a prime mover power of the k-th synchronous machine, P_{gk} is an output power of the k-th synchronous machine, M_{COI} is a center of inertia time constant of the n-th synchronous machine, P_{COI} is an inertia center power of the n-th synchronous machine, k is a serial number of the current synchronous machine, and n is a total number of synchronous machines;

According to the synchronous machine rotor motion equation, the Lyapunov function of the synchronous machine based on the new energy power system is constructed;

According to the Lyapunov function, the stability domain boundary of the synchronous machine with respect to the state variables is obtained, and the stability domain boundary is the maximum level set of the Lyapunov function; the intersection of the Lyapunov function and the preset area D is obtained, thereby obtaining the stability domain boundary represented by the maximum level set of the Lyapunov function.

Based on the stability domain boundary, the transient stability of the new synchronous machine is judged according to the real-time numerical values of the state variables after the fault. The transient stability of the synchronous machine is judged by observing whether the state variables of the new energy power system after the fault (synchronous machine rotor angular velocity and synchronous machine rotor position angle) are within the stability domain boundary, thereby conducting a safety and stability analysis of the new energy power system.

For a complex multi-machine power system with new energy access, the potential nodes in the synchronous machine and the new energy grid connection points in the system are retained, and the reduced admittance matrix of the new energy power system can be obtained as formula (3):

$$[ \begin{matrix}{Y}_{gg} & {Y}_{gw} \\ {Y}_{wg} & {Y}_{ww}\end{matrix} ] [ \begin{matrix}{E}_{g} \\ {U}_{b}\end{matrix} ] = [ \begin{matrix}{I}_{g} \\ {I}_{w}\end{matrix} ] \qquad ( 3 )$$

Where, Y_{ww} is the self-admittance of the new energy grid connection point, Y_{gw}, Y_{wg} are the mutual admittances between the potential nodes in the synchronous machine and the new energy grid connection point, Y_{gg} is the self-admittance of the potential node in the synchronous machine, E_{g} is the column vector composed of the transient potential of each synchronous machine, U_{b} is the column vector composed of the voltage of each new energy grid connection point, I_{g} is the column vector composed of the injected current of each synchronous machine, I_{w} is the column vector composed of the injected current of each new energy grid connection point;

From formula (3), the voltage of the new energy grid connection point can be solved by formula (4) and formula (5):

$${U}_{b} = {Y}_{ww}^{- 1} ( {I}_{w} - {Y}_{wg} {E}_{g} ) \qquad ( 4 )$$

$${I}_{w} - {Y}_{ww} {U}_{b} = {Y}_{wg} {E}_{g} \qquad ( 5 )$$

Considering that the new energy grid connection point in the new energy power system is equivalent to a new energy grid connection point, that is, Y_{ww} contains one element, expanding equation (5) into the amplitude and phase angle form, we have equation (6) and equation (7):

$${I}_{w} ∠ {δ}_{w} = - {Y}_{ww} {U}_{b} ∠ {δ}_{w} = {Y}_{wg} {E}_{g} {∠δ}_{g} \qquad ( 6 )$$

$${I}_{w} ∠ {δ}_{w} - \frac{{U}_{b} {∠δ}_{w}}{{jX}_{ww}} = - \frac{{E}_{g} {∠δ}_{g}}{{jX}_{wg}} \qquad ( 7 )$$

In the formula, δ_{w} is the phase angle of I_{w}, δ_{g} is the synchronous machine rotor position angle, j is the imaginary number symbol, X_{ww} is the self-reactance of the new energy grid connection point, X_{wg} is the mutual reactance between the synchronous machine and the new energy grid connection point;

Considering that there are n synchronous machines and l new energy grid connection points in the new energy power system, and the new energy grid connection points only output active power, that is, the phase of I_{w} is the same as that of U_{b}, then the voltage of the i-th new energy grid connection point can be expressed as formula (8):

$${I}_{wi} {∠δ}_{bi} - \frac{{U}_{bi}}{{X}_{wwi}} ∠ ( {δ}_{bi} - \frac{π}{2} ) = \frac{{E}_{g}}{{X}_{wg}} ∠ ( {δ}_{g} + \frac{π}{2} ) \qquad ( 8 )$$

Further solving equation (8) yields equation (9):

$$\sqrt{{I}_{wi}^{2} + \frac{{U}_{bi}^{2}}{{X}_{wwi}^{2}}} ∠ ( {δ}_{bi} + {tan}^{- 1} \frac{{U}_{bi}}{{X}_{wwi} {I}_{wi}} ) = {\sum }_{m = 1}^{n} \frac{{E}_{gm}}{{X}_{wgim}} ∠ ( {δ}_{gm} + \frac{π}{2} ) \qquad ( 9 )$$

From formula (9), the expression of the voltage of the new energy grid connection point is:

$$\sqrt{{I}_{wi}^{2} + \frac{{U}_{bi}^{2}}{{X}_{wwi}^{2}}} = \sqrt{{( {\sum }_{m = 1}^{n} \frac{{E}_{gm}}{{X}_{wgim}} sin {δ}_{gm} )}^{2} + {( {\sum }_{m = 1}^{n} \frac{{E}_{gm}}{{X}_{wgim}} cos {δ}_{gm} )}^{2}} \qquad ( 10 )$$

Solving equation (10), we get the voltage of the new energy grid connection point as equation (11):

$${U}_{bi} = {X}_{wwi} \sqrt{{( {\sum }_{m = 1}^{n} \frac{{E}_{gm}}{{X}_{wgim}} sin {δ}_{gm} )}^{2} + {( {\sum }_{m = 1}^{n} \frac{{E}_{gm}}{{X}_{wgim}} cos {δ}_{gm} )}^{2} - {I}_{wi}^{2}} \qquad ( 11 )$$

In addition, the expression of the voltage phase angle of the new energy grid connection point is obtained from formula (9):

$${δ}_{bi} + arctan \frac{{U}_{bi}}{{X}_{wwi} {I}_{wi}} = {tan}^{- 1} ( {\sum }_{m = 1}^{n} \frac{{E}_{gm}}{{X}_{wgim}} sin ( {δ}_{gm} + \frac{π}{2} ) / {\sum }_{m = 1}^{n} \frac{{E}_{gm}}{{X}_{wgim}} cos ( {δ}_{gm} + \frac{π}{2} ) ) \qquad ( 12 )$$

Solving equation (12), the voltage phase angle of the new energy grid connection point is:

$${δ}_{bj} = {tan}^{- 1} ( {\sum }_{m = 1}^{n} \frac{{E}_{gm}}{{X}_{wgim}} cos {δ}_{gm} / ( - {\sum }_{m = 1}^{n} \frac{{E}_{gm}}{{X}_{wgim}} sin {δ}_{gm} ) ) - arctan \frac{{U}_{bi}}{{X}_{wwi} {I}_{wi}} \qquad ( 13 )$$

In the formula, U_{bi} is a voltage of the i-th new energy grid connection point, X_{wwi} is a self-reactance of the i-th new energy grid connection point, m is a serial number of the synchronous machine, n is a total number of synchronous machines, E_{gm} is an internal potential of the m-th synchronous machine, X_{wgim} is a reactance between the m-th synchronous machine and the i-th new energy grid connection point, δ_{gm} is a rotor position angle of the m-th synchronous machine, I_{wi} is an injected current of the i-th new energy grid connection point, and δ_{bi} is a voltage phase angle of the i-th new energy grid connection point.

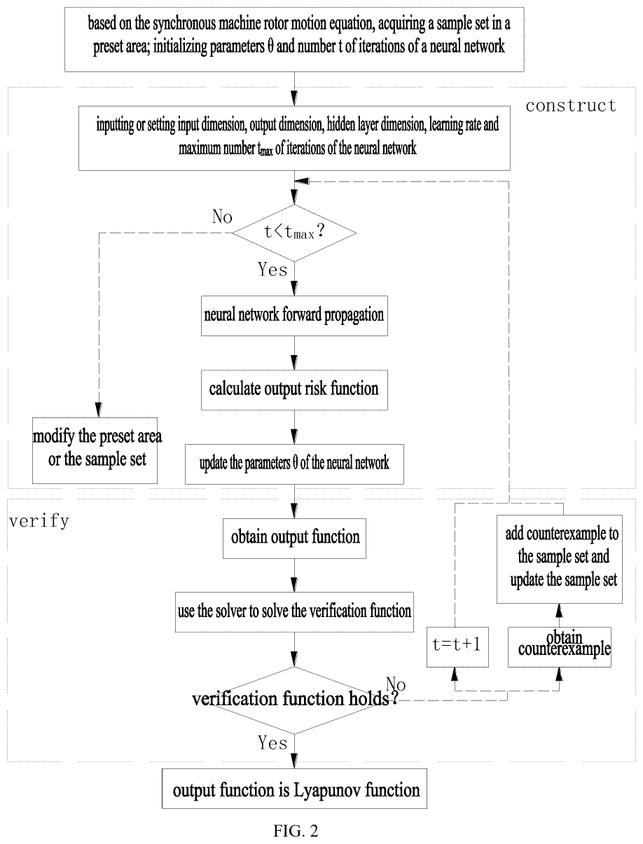

In some optional embodiments, referring to FIG. 2, the steps of constructing the Lyapunov function are:
based on the synchronous machine rotor motion equation, acquiring a sample set in a preset area, wherein the sample set is a set of values of the state variables;
initializing parameters and number of iterations of a neural network;
obtaining an output scalar function based on the sample set and the parameters of the neural network;
obtaining an output risk function according to the sample set, the parameters of the neural network, the output scalar function and the motion equation;
inputting or setting operating parameters of the neural network, the operating parameters comprising input dimension, output dimension, hidden layer dimension, learning rate and maximum number of iterations; obtaining the input dimension according to the synchronous machine rotor motion equation, and obtaining the output dimension according to the output scalar function; optionally, a three-layer neural network with a preset hidden layer dimension of 7 and a learning rate of 0.01 is selected; during the operation, stochastic gradient descent is used as the optimizer;
obtaining an activation function of the neural network; optionally, using the tanh function as the activation function, and in addition, the activation function is selected to be a function that can be derivated and whose function value includes both positive and negative values;
running the neural network based on the operating parameters, the parameters of the neural network, the number of iterations, the activation function, the output scalar function, and the output risk function, to obtain an output function;
obtaining the Lyapunov function of synchronous machine based on the new energy power system according to the output function.

In some optional embodiments, also referring to FIG. 2, the operation steps of the neural network comprises:
Step 1: determine whether t<tₘₐₓ is met, where t is the number of iterations and tₘₐₓ is the maximum number of iterations:
if not, modify the preset area or the sample set;
if yes, run the neural network;
Step 2: update the parameters of the neural network according to the output risk function, and obtain the output function according to the output scalar function;
Step 3: determine whether the output function meets an output verification condition:
if the output function does not meet the output verification condition, then t=t+1, repeat step 1 to step 2;
if the output function meets the output verification condition, then the output function is set as the Lyapunov function.

The training process of the neural network is to update the parameters θ of the neural network to improve the output function to meet the output verification condition. On this basis, a loss function is established, it is defined as the output risk function. The output risk function is used to measure the degree to which the output function violates the output verification condition. Since the expected value of the parameters θ of the neural network must make the output function positive definite, and make the derivative of the output function negative definite, and V(0)=0, the output risk function is defined as:

$$L ( x ; θ ) = \frac{1}{N} {\sum }_{s = 1}^{N} ( {h}_{1} ( \hat{V} ( {x}_{s} ; θ ) ) + {h}_{2} ( {∇}_{x} {\hat{V} ( {x}_{s} ; θ )}^{T} f ( {x}_{s} ) ) ) + {\hat{V}}^{2} ( 0 ) ;$$

The first term corresponds to the positive definiteness of the output function, the second term corresponds to the negative definiteness of the derivative of the output function, and the third term represents the satisfaction of V(0)=0. Since the desired output function is positive definite, negative values of the output function must be penalized. Correspondingly, the derivative of the output function with positive values should be penalized. In order to avoid the output function and the derivative of the output function collapsing on zero, margin m₁ and margin m₂ are introduced, where:

$${h}_{1} ( V ) = \{ \begin{matrix}0 if V > {m}_{1} \\ - V + {m}_{1} if V \leq {m}_{1}\end{matrix} ,$$

$${h}_{2} ( \dot{V} ) = \{ \begin{matrix}\dot{V} + {m}_{2} if \dot{V} > - {m}_{2} \\ 0 if \dot{V} \leq - {m}_{2}\end{matrix} ;$$

In the formula, L is an output risk function, x is a value of state variable, θ is a parameter of the neural network, N is a total number of samples, s is a sample number, xₛ is a value of the state variable of the s-th sample, f is a function corresponding to the synchronous machine rotor motion equation, ∇ₓ is a partial differential with respect to x, T represents a transpose, h₁ is a constraint function of V, h₂ is a constraint function of \dot{V}, \hat{V} is an output scalar function, m₁ is a margin of the output function from the origin, m₂ is a margin of the derivative of the output function from the origin, m₁≥0, m₂≥0, V is the output function, and \dot{V} is the derivative of the output function.

In some optional embodiments, the step of determining whether the output function meets the output verification condition is:
based on a solver, obtaining a verification function according to the sample set and the output function; the task of the verification function is to find the vector of state variables in the output function that violate the output verification condition. The verification function is the first-order logic formula on following real numbers;

$${Φ}_{s} ( x ) = ( {\sum }_{s = 1}^{N} {x}_{s}^{2} \geq ε ) ⋀ ( V ( x ) \leq 0 ⋁ \dot{V} ( x ) \geq 0 ) ;$$

Where: Φ is the verification function, N is the total number of samples, s is the sample number, xₛ is the value of the state variable of the s-th sample, ε is a small constant parameter that limits a tolerable numerical error, x is the value of the state variable, x is bounded in the preset space D, V is the output function, \dot{V} is the derivative of the output function, and ε, ε∈Q⁺ are introduced to control the numerical sensitivity near the origin, Q⁺ is a set of positive rational numbers;

This ε effectively avoids ill-conditioned problems in numerical algorithms, such as arithmetic underflow. The values inside this small ball correspond to physically insignificant perturbations. This ε is very important for eliminating common numerical sensitivity problems in this algorithm. It should also be noted that ε ball does not affect the properties of the Lyapunov level set and its outer attraction region.

Solvers are used to solve the verification function and it is determined whether the verification function holds; solving the verification function, i.e. solving these constraints, requires global minimization of highly non-convex functions (including the derivative of the output function), it is a computationally complex and time-consuming task. It can rely on the results achieved in solving nonlinear constraints in Satisfiability Modulo Theories (SMT) solvers, such as dReal, which is prior art and has been used for similar design problems that do not involve neural networks.

Therefore, the SMT solver is used to verify whether the output function obtained in the previous step meets the output verification condition. If the output function does not meet the output verification condition, that is, the verification function does not hold, then the obtained counterexample is added to the sample set X to accelerate convergence. If the verification function holds, then the output function is the Lyapunov function that meets the output verification condition.

In some optional embodiments, also referring to FIG. 2, when the verification function does not hold, the state variable value of the output function that does not meet the output verification condition is obtained according to the verification function, the state variable value of the output function that does not meet the output verification condition is added to the sample set as a counterexample, and the sample set is updated to speed up the construction rate of the Lyapunov function; Steps 1 to 2 are repeated based on the updated sample set.

Furthermore, the output verification condition is:
V(0)=0 and V(x)>0 in D−{0},
V(x)<0 in D−{0};

In the formula, V is the output function, x is the value of the state variable, D is the preset area, and \dot{V} is the derivative of the output function.

### EXAMPLES

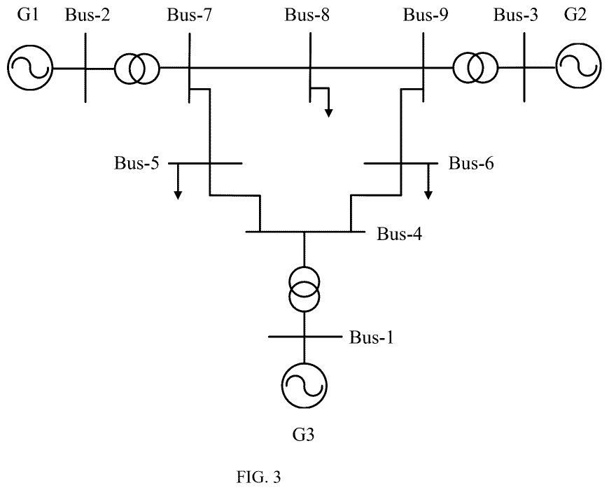

In this example, the new energy power system is a three-machine nine-node system, see FIG. 3, where G1 is the first synchronous machine, G2 is the second synchronous machine, G3 is the new energy station, and Bus-1 is the new energy grid connection point; retaining the potential nodes in the synchronous machine and the new energy grid connection point, the reduced admittance matrix of the new energy power system can be obtained as follows:

$$[ \begin{matrix}{Y}_{11} & {Y}_{12} & {Y}_{13} \\ {Y}_{21} & {Y}_{22} & {Y}_{23} \\ {Y}_{31} & {Y}_{32} & {Y}_{33}\end{matrix} ] [ \begin{matrix}{\dot{E}}_{g 1} \\ {\dot{E}}_{g 2} \\ {\dot{U}}_{b}\end{matrix} ] = [ \begin{matrix}{\dot{I}}_{g 1} \\ {\dot{I}}_{g 2} \\ {\dot{I}}_{w}\end{matrix} ]$$

Then the voltage U_{b} of the new energy grid connection point can be expressed as:

$${\dot{U}}_{b} = {Y}_{33}^{- 1} ( {I}_{w} - {Y}_{31} {\dot{E}}_{g 1} - {Y}_{32} {\dot{E}}_{g 2} )$$

Considering that the new energy grid connection point only outputs active current, the phasor form is expanded to the following relationship:

$${Y}_{33} {\dot{U}}_{b} {∠δ}_{b} - {\dot{I}}_{w} {∠δ}_{b} = - {Y}_{33} {\dot{E}}_{g 1} {∠δ}_{g 1} - {Y}_{33} {\dot{E}}_{g 2} {∠δ}_{g 2}$$

For the high-voltage transmission network, ignoring the line resistance, and since there is only one new energy station in this example, that is, there is only one new energy grid connection point, then U_{bi}=U_{b1}=U_{b}, δ_{bi}=δ_{b1}=δ_{b}, we can get:

$${I}_{w} {∠δ}_{b} - \frac{{U}_{b} {∠δ}_{b}}{j ( {X}_{13} + {X}_{23} )} = - \frac{{E}_{g 1} {∠δ}_{g 1}}{{jX}_{13}} - \frac{{E}_{g 2} {∠δ}_{g 2}}{{jX}_{23}}$$

Further written in the form of amplitude and phase angle, we have:

$$\sqrt{{I}_{w}^{2} + \frac{{U}_{b}^{2}}{{X}_{33}^{2}}} ∠ ( {δ}_{b} + arctan \frac{{U}_{b}}{{X}_{33} {I}_{w}} ) = \frac{{E}_{g 1}}{{X}_{13}} ∠ ( {δ}_{g 1} + \frac{π}{2} ) + \frac{{E}_{g 2} {∠δ}_{g 2}}{{X}_{23}} ∠ ( {δ}_{g 2} + \frac{π}{2} )$$

Solved: The voltage of the new energy grid connection point is:

$${U}_{b} = {X}_{33} \sqrt{{( \frac{{E}_{g 1}}{{X}_{13}} sin {δ}_{g 1} + \frac{{E}_{g 2}}{{X}_{12}} sin {δ}_{g 2} )}^{2} + {( \frac{{E}_{g 1}}{{X}_{13}} cos {δ}_{g 1} + \frac{{E}_{g 2}}{{X}_{12}} cos {δ}_{g 2} )}^{2} - {I}_{w}^{2}}$$

The voltage phase angle of the new energy grid connection point is:

$${δ}_{b} = {Tan}^{- 1} \frac{\frac{{E}_{g 1}}{{X}_{13}} cos {δ}_{g 1} + \frac{{E}_{g 2}}{{X}_{23}} cos {δ}_{g 2}}{- \frac{{E}_{g 1}}{{X}_{13}} sin {δ}_{g 1} + \frac{{E}_{g 2}}{{X}_{23}} sin {δ}_{g 2}} - arctan \frac{{U}_{b}}{{I}_{w} {X}_{33}}$$

Substituting the voltage of the new energy grid connection point and the voltage phase angle of the new energy grid connection point into equation (1) to obtain the output power of the synchronous machine, and then substituting it into the synchronous machine rotor motion equation, the rotor motion equation of the synchronous machine G1 is obtained as follows:

$$\{ \begin{matrix}\frac{d {δ}_{g 1}}{dt} & = {ω}_{1} \\ {M}_{1} \frac{d {ω}_{1}}{dt} & = {P}_{1} - \frac{{E}_{1} {E}_{2}}{{X}_{12}} sin ( {δ}_{g 1} - {δ}_{g 2} ) - \frac{{E}_{1} {U}_{b}}{{X}_{13}} sin ( {δ}_{g 1} - {δ}_{b} ) - \frac{{M}_{1}}{{M}_{COI}} {P}_{COI}\end{matrix} ;$$

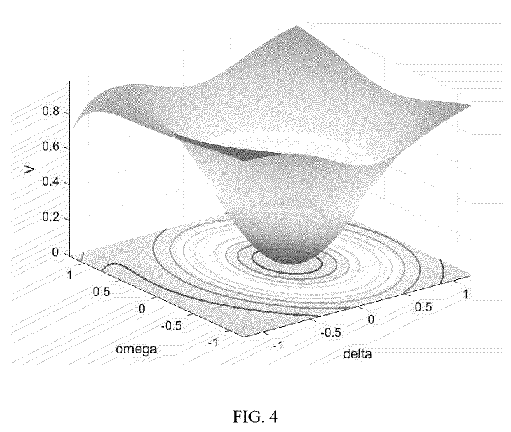

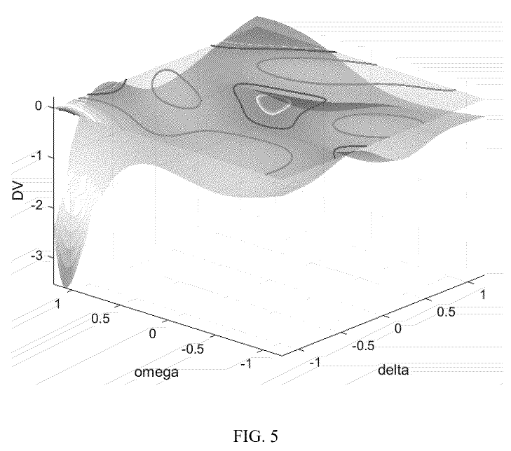

According to the rotor motion equation of the synchronous machine G1, based on the new energy power system, the neural network is used to implement training and obtain the Lyapunov function of the synchronous machine G1 under working condition 1. Working condition 1 is: δ_{g2}=0, T_{J1}=42, D=42, I_{wi}=I_{w1}=I_{w}=3, M₁=T_{J1}/314, the Lyapunov function and its derivative are shown in FIGS. 4 and 5. FIG. 4 is the Lyapunov function of the synchronous machine G1 under working condition 1, and FIG. 5 is the derivative of the Lyapunov function of the synchronous machine G1 under working condition 1;

The stability domain boundaries of the state variables, synchronous machine rotor position angle and synchronous machine rotor angular velocity, are obtained according to the Lyapunov function of the synchronous machine G1; based on the stability domain boundaries, the transient stability of the synchronous machine G1 is judged according to the real-time values of the state variables after the fault.

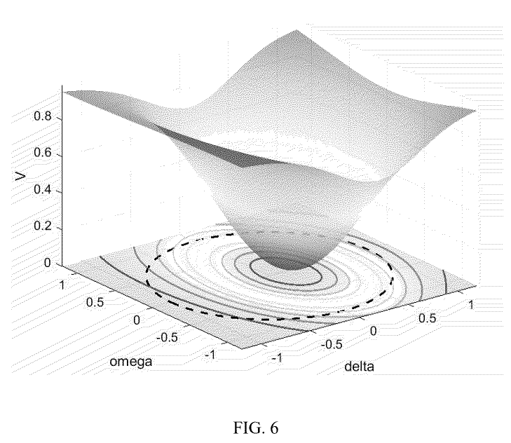

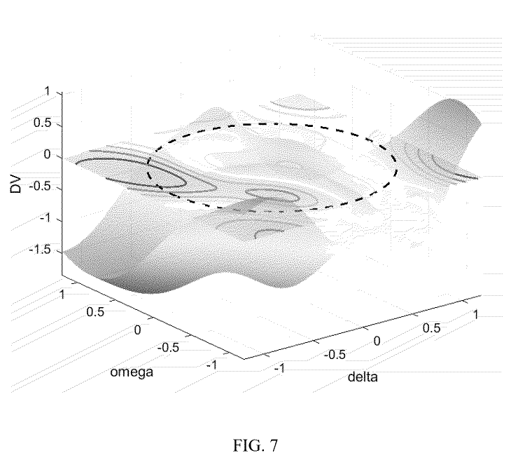

According to the rotor motion equation of the synchronous machine G1, based on the new energy power system, the neural network is used to implement training and obtain the Lyapunov function of the synchronous machine G1 under working condition 2. Working condition 2 is: δ_{g2}=0, T_{J1}=16, D=25, I_{wi}=I_{w1}=I_{w}=3, M₂=T_{J1}/314, the Lyapunov function and its derivative are shown in FIGS. 6 and 7. FIG. 6 is the Lyapunov function of the synchronous machine G1 under working condition 2, and FIG. 7 is the derivative of the Lyapunov function of the synchronous machine G1 under working condition 2;

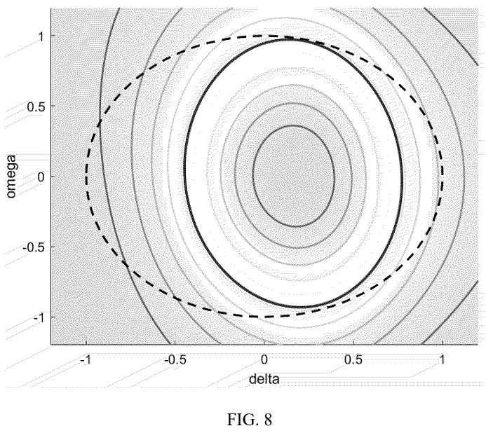

According to the Lyapunov function of the synchronous machine G1, the stability domain boundary of the state variables, the synchronous machine rotor position angle and the synchronous machine rotor angular velocity, is obtained, as shown in FIG. 8, the blue line is the stability domain boundary; based on the stability domain boundary, the transient stability of the synchronous machine G1 is judged according to the real-time numerical value of the state variables after the fault.

Similarly, the rotor motion equation of synchronous machine G2 can be derived as follows:

$$\{ \begin{matrix}\frac{d {δ}_{g 2}}{dt} & = {ω}_{2} \\ {M}_{2} \frac{d {ω}_{2}}{dt} & = {P}_{2} - \frac{{E}_{1} {E}_{2}}{{X}_{12}} sin ( {δ}_{g 2} - {δ}_{g 1} ) - \frac{{E}_{1} {U}_{b}}{{X}_{23}} sin ( {δ}_{g 2} - {δ}_{b} ) - \frac{{M}_{2}}{{M}_{COI}} {P}_{COI}\end{matrix} ;$$

According to the rotor motion equation of the synchronous machine G2 and based on the new energy power system, a neural network is used to implement training and obtain the Lyapunov function of the synchronous machine G2 under preset working conditions. According to the Lyapunov function of the synchronous machine G2, the stability domain boundaries of the state variables, the synchronous machine rotor position angle and the synchronous machine rotor angular velocity, are obtained; based on the stability domain boundaries, the transient stability of the synchronous machine G2 is judged according to the real-time numerical values of the state variables after the fault.

The system embodiment described above is merely illustrative, wherein the units described as separate components may or may not be physically separated, and the components shown as units may or may not be physical units, that is, they may be located in one place, or they may be distributed on multiple network units. Some or all of the modules may be selected according to actual needs to achieve the purpose of the solution of this embodiment. Those of ordinary skill in the art may understand and implement it without creative effort.

Through the description of the above implementation methods, those skilled in the art can clearly understand that each implementation method can be implemented by means of software plus a necessary general hardware platform, and of course, it can also be implemented by hardware. Based on this understanding, the above technical solution is essentially or the part that contributes to the prior art can be embodied in the form of a software product, and the computer software product can be stored in a computer-readable storage medium, such as ROM/RAM, a disk, an optical disk, etc., including a number of instructions for a computer device (which can be a personal computer, a server, or a network device, etc.) to execute the methods described in each embodiment or some parts of the embodiments.

The above is only an optional embodiment of the present disclosure. It should be pointed out that for ordinary technicians in this technical field, several improvements and modifications can be made without departing from the technical principles of the present disclosure. These improvements and modifications should also be regarded as the scope of protection of the present disclosure.

What is claimed is:

1. A safety and stability analysis method for a new energy power system comprising a synchronous machine based on Lyapunov function, comprising following steps:
obtaining a new energy grid connection point voltage, a new energy grid connection point voltage phase angle, an internal potential of a synchronous machine, a line susceptance and a rotor position angle of the synchronous machine of the new energy power system;
obtaining an output power of synchronous machine according to the new energy grid connection point voltage, the new energy grid connection point voltage phase angle, the internal potential of the synchronous machine, the line susceptance and the rotor position angle of the synchronous machine, wherein the output power of synchronous machine is:
$${P}_{gk} = {E}_{gk} {\sum }_{m = 1}^{n} {E}_{gm} {B}_{mk} sin ( {δ}_{gk} - {δ}_{gm} ) + {E}_{gk} {\sum }_{i = 1}^{i} {U}_{bi} {B}_{wgik} sin ( {δ}_{gk} - {δ}_{bi} ) ;$$
where, P_{gk} is an output power of the k-th synchronous machine, E_{gk} is an internal potential of the k-th synchronous machine, k is a serial number of the current synchronous machine, m is a serial number of the synchronous machine, n is a total number of synchronous machines, E_{gm} is an internal potential of the m-th synchronous machine, Bₘₖ is a line susceptance between the k-th synchronous machine and the m-th synchronous machine, δ_{gk} is a rotor position angle of the k-th synchronous machine, δ_{gm} is a rotor position angle of the m-th synchronous machine, i is a serial number of the new energy grid connection point, l is a total number of new energy grid connection points, U_{bi} is a voltage of the i-th new energy grid connection point, B_{wgik} is a line susceptance between the k-th synchronous machine and the i-th new energy grid connection point, and δ_{bi} is a voltage phase angle of the i-th new energy grid connection point;
obtaining an inertia constant of synchronous machine, a prime mover power of synchronous machine and a center of inertia time constant of synchronous machine based on the new energy power system;
obtaining a synchronous machine rotor motion equation according to the inertia constant of synchronous machine, the prime mover power of synchronous machine and the center of inertia time constant of synchronous machine and the output power of synchronous machine, wherein state variables of the synchronous machine rotor motion equation comprises a synchronous machine rotor position angle and a synchronous machine rotor angular velocity;
constructing a Lyapunov function of synchronous machine based on the new energy power system according to the synchronous machine rotor motion equation;
obtaining a stability domain boundary of the synchronous machine with respect to the state variables according to the Lyapunov function;
based on the stability domain boundary, determining a transient stability of the synchronous machine according to real-time values of post-fault state variables; and
adjusting the operation of the synchronous machine according to the transient stability of the synchronous machine;
wherein the step of constructing the Lyapunov function comprises:
based on the synchronous machine rotor motion equation, acquiring a sample set in a preset area, wherein the sample set is a set of values of the state variables;
initializing parameters and number of iterations of a neural network;
obtaining an output scalar function based on the sample set and the parameters of the neural network;
obtaining an output risk function according to the sample set, the parameters of the neural network, the output scalar function and the motion equation;
inputting or setting operating parameters of the neural network, the operating parameters comprising input dimension, output dimension, hidden layer dimension, learning rate and maximum number of iterations; obtaining the input dimension according to the synchronous machine rotor motion equation, and obtaining the output dimension according to the output scalar function;
obtaining an activation function of the neural network;
running the neural network based on the operating parameters, the parameters of the neural network, the number of iterations, the activation function, the output scalar function, and the output risk function, to obtain an output function;
obtaining the Lyapunov function of synchronous machine based on the new energy power system according to the output function.

2. The method according to claim 1, wherein the new energy grid connection point voltage is:
$${U}_{bi} = {X}_{wwi} \sqrt{{( {\sum }_{m = 1}^{n} \frac{{E}_{gm}}{{X}_{wgim}} sin {δ}_{gm} )}^{2} + {( {\sum }_{m = 1}^{n} \frac{{E}_{gm}}{{X}_{wgim}} cos {δ}_{gm} )}^{2} - {I}_{wi}^{2}} ;$$
the new energy grid connection point voltage phase angle is:
$${δ}_{bi} = {tan}^{- 1} ( {\sum }_{m = 1}^{n} \frac{{E}_{gm}}{{X}_{wgim}} cos {δ}_{gm} / ( - {\sum }_{m = 1}^{n} \frac{{E}_{gm}}{{X}_{wgim}} sin {δ}_{gm} ) ) - arctan \frac{{U}_{bi}}{{X}_{wwi} {I}_{wi}}$$
where, U_{bi} is a voltage of the i-th new energy grid connection point, X_{wwi} is a self-reactance of the i-th new energy grid connection point, m is a serial number of the synchronous machine, n is a total number of synchronous machines, E_{gm} is an internal potential of the m-th synchronous machine, X_{wgim} is a reactance between the m-th synchronous machine and the i-th new energy grid connection point, δ_{gm} is a rotor position angle of the m-th synchronous machine, I_{wi} is an injected current of the i-th new energy grid connection point, and δ_{bi} is a voltage phase angle of the i-th new energy grid connection point.

3. The method according to claim 1, wherein the synchronous machine rotor motion equation is:
$$\{ \begin{matrix}\frac{d {δ}_{gk}}{dt} & = {ω}_{k} \\ {M}_{k} \frac{d {ω}_{k}}{dt} & = {P}_{k} - {P}_{gk} - \frac{{M}_{k}}{{M}_{COI}} {P}_{COI}\end{matrix} ;$$
$$where :$$
$${M}_{COI} = {\sum }_{k = 1}^{n} {M}_{k} ;$$
$${P}_{COI} = {\sum }_{k = 1}^{n} ( {P}_{k} - {P}_{gk} ) ;$$
where, δ_{gk} is a rotor position angle of the k-th synchronous machine, Φₖ is a rotor angular velocity of the k-th synchronous machine, Mₖ is an inertia time constant of the k-th synchronous machine, Pₖ is a prime mover power of the k-th synchronous machine, P_{gk} is an output power of the k-th synchronous machine, M_{COI} is a center of inertia time constant of the n-th synchronous machine, P_{COI} is an inertia center power of the n-th synchronous machine, k is a serial number of the current synchronous machine, and n is a total number of synchronous machines.

4. (canceled)

5. The method according to claim 1, wherein the operation steps of the neural network comprises:
Step 1: determine whether t<tₘₐₓ is met, where t is the number of iterations and tₘₐₓ is the maximum number of iterations:
if not, modify the preset area or the sample set;
if yes, run the neural network;
Step 2: update the parameters of the neural network according to the output risk function, and obtain the output function according to the output scalar function;
Step 3: determine whether the output function meets an output verification condition:
if the output function does not meet the output verification condition, then t=t+1, repeat step 1 to step 2;
if the output function meets the output verification condition, then the output function is set as the Lyapunov function.

6. The method according to claim 5, wherein the output risk function is:
$$L ( x ; θ ) = \frac{1}{N} {{\sum }_{x = 1}}^{N} ( {h}_{1} ( \hat{V} ( {x}_{s} ; θ ) ) + {h}_{2} ( {∇}_{x} {\hat{V} ( {x}_{s} ; θ )}^{T} f ( {x}_{s} ) ) ) + {\hat{V}}^{2} ( 0 ) ;$$
$$where :$$
$${h}_{1} ( V ) = \{ \begin{matrix}0 & if V > {m}_{1} \\ - V + {m}_{1} & if V \leq {m}_{1}\end{matrix} ,$$
$${h}_{2} ( \dot{V} ) = \{ \begin{matrix}\dot{V} + {m}_{2} & if \dot{V} > - {m}_{2} \\ 0 & if \dot{V} \leq {m}_{2}\end{matrix} ;$$
where, L is an output risk function, x is a value of state variable, θ is a parameter of the neural network, N is a total number of samples, s is a sample number, xₛ is a value of the state variable of the s-th sample, f is a function corresponding to the synchronous machine rotor motion equation, ∇ₓ is a partial differential with respect to x, T represents a transpose, h₁ is a constraint function of V, h₂ is a constraint function of \dot{V}, Û is an output scalar function, m₁ is a margin of the output function from the origin, m₂ is a margin of the derivative of the output function from the origin, m₁≥0, m₂≥0, V is the output function, and \dot{V} is the derivative of the output function.

7. The method according to claim 5, wherein the step of determining whether the output function meets the output verification condition comprises:
based on a solver, obtaining a verification function according to the sample set and the output function, wherein the verification function is:
$${Φ}_{ε} ( x ) = ( {\sum }_{s = 1}^{N} {x}_{s}^{2} \geq ε ) ⋀ ( V ( x ) \leq 0 ⋁ \dot{V} ( x ) \geq 0 ) ;$$
where: Φ is the verification function, N is the total number of samples, s is the sample number, xₛ is the value of the state variable of the s-th sample, ε is a small constant parameter that limits a tolerable numerical error, x is the value of the state variable, V is the output function, \dot{V} is the derivative of the output function, ε∈Q⁺, Q⁺ is a set of positive rational numbers;
using the solver to solve the verification function and determining whether the verification function holds;
if the verification function does not hold, then the output function does not meet the output verification condition;
if the verification function holds, the output function meets the output verification condition.

8. The method according to claim 7, wherein when the verification function does not hold, the value of state variable of the output function that does not meet the output verification condition is obtained according to the verification function, and the value of state variable of the output function that does not meet the output verification condition is added to the sample set, and the sample set is updated; and the Steps 1 to 2 are repeated based on the updated sample set.

9. The method according to claim 5, wherein the output verification condition is:
V(0)=0 and V(x)>0 in D−{0},
V(x)<0 in D−{0};
where, V is the output function, x is the value of the state variable, D is the preset area, and \dot{V} is the derivative of the output function.

10. The method according to claim 1, wherein the hidden layer dimension is 7.
